(19) United States
(12) Patent Application Publication
(10) Pub. No.: US 2022/0020986 A1
(43) Pub. Date: Jan. 20, 2022

(54) ELECTRODE PLATE MATERIAL OF LITHIUM-ION BATTERY

(71) Applicant: CHINA STEEL CHEMICAL CORPORATION, Kaohsiung City (TW)

(72) Inventors: Po-chin CHEN, Kaohsiung City (TW); Wei-chih CHEN, Kaohsiung City (TW); Yi-hsun CHEN, Kaohsiung City (TW); Hsiang-yu HSU, Kaohsiung City (TW); Kai-Chih HSU, Kaohsiung City (TW); Yuan-ping YANG, Kaohsiung City (TW)

(21) Appl. No.: 17/373,845

(22) Filed: Jul. 13, 2021

(30) Foreign Application Priority Data
Jul. 20, 2020 (TW) 109124489

(51) Int. Cl. H01M 4/583; H01M 4/134; H01M 4/38; H01M 10/0525; H01M 4/133; H01M 4/36; H01M 4/62

(52) U.S. Cl. CPC H01M 4/583; H01M 4/134; H01M 4/386; H01M 10/0525; H01M 2004/027; H01M 4/366; H01M 4/622; H01M 4/626; H01M 4/133

(57) ABSTRACT

An electrode material of a lithium-ion battery is provided. The electrode material of the lithium-ion battery has 5 to 70 parts by weight of unbuffered active material; and 30 to 95 parts by weight of buffered active material. By adding a specific proportion of a buffered material (such as the graphite material particles), the electrode material of the lithium-ion battery avoids or reduces breakage or cracking of the unbuffered active material themselves or the shell thereof during a rolling step, so a cycle life of a battery can be improved.

### CROSS REFERENCE TO RELATED APPLICATION

This application claims priority to Taiwan Patent Application No. 109124489, filed on Jul. 20, 2020, which is incorporated herein by reference in its entirety.

### FIELD OF DISCLOSURE

The present disclosure relates to lithium-ion batteries, and more particularly to an electrode plate material of a lithium-ion battery.

### BACKGROUND OF DISCLOSURE

Because primary batteries do not meet environmental requirements, rechargeable secondary battery systems have gradually attracted attention in recent years. With the rapid development and generalization of portable electronic products, lithium-ion secondary batteries have characteristics of light weight, high voltage value and high energy density, resulting in a rapid increase in market demand. Compared with nickel-hydride, nickel-zinc, and nickel-cadmium batteries, lithium-ion batteries have advantages of high working voltage, high energy density, light weight, long life, and good environmental protection. They are also the best choice for flexible batteries in the future.

Electrode plates used in lithium-ion batteries generally need to be rolled to increase the plate density. Generally, active materials are easily crushed or cracked during the rolling process. Therefore, it is necessary to provide an electrode plate material of a lithium-ion battery to solve the problems of conventional technologies.

### SUMMARY OF DISCLOSURE

An object of the present disclosure is to provide an electrode plate material of a lithium-ion battery. By adding a specific proportion of a buffered material (such as the graphite material particles), the present disclosure avoids or reduces breakage or cracking of the unbuffered active material themselves or the shell thereof during a rolling step, so a cycle life of a battery can be improved.

To achieve the above object, the present disclosure provides an electrode plate material of a lithium-ion battery comprising: 5 to 70 parts by weight of unbuffered active material, comprising: a core; and a shell covering the core; and 30 to 95 parts by weight of buffered active material.

In an embodiment of the present disclosure, the buffered active material comprises at least one of natural graphite, artificial graphite, or artificial conductive graphite.

In an embodiment of the present disclosure, the electrode plate material of lithium-ion battery further comprises a thickener greater than 0 and less than or equal to 5 parts by weight.

In an embodiment of the present disclosure, the thickener comprises at least one of carboxymethyl cellulose, sodium polyacrylate, other silicon acrylate polymers, or fatty acid esters.

In an embodiment of the present disclosure, the electrode plate material of lithium-ion battery further comprises an adhesive greater than 0 and less than or equal to 5 parts by weight.

In an embodiment of the present disclosure, the adhesive comprises at least one of polyvinylidene fluoride, styrene butadiene rubber, polyethylene, polypropylene, ethylene propylene polymer, butadiene rubber, butyl rubber, polyethylene oxide, polyepichlorohydrin, polyphosphazene, polyacrylonitrile, or polyimide.

In an embodiment of the present disclosure, the electrode plate material of lithium-ion battery further comprises a conductive additive greater than 0 and less than or equal to 5 parts by weight.

In an embodiment of the present disclosure, the conductive additive comprises at least one of metal powder, metal fiber, or conductive carbon substrate.

In an embodiment of the present disclosure, an average particle size of the core is between 16 and 20 microns, and a thickness of the shell is between 2 and 3 microns, wherein the shell comprises an amorphous carbon shell and nano-silicon dispersed on the amorphous carbon shell.

In an embodiment of the present disclosure, the buffered active material is softer than the unbuffered active material.

### DESCRIPTION OF DRAWINGS

FIG. 1A is a schematic cross-sectional view of an electrode plate material of a general lithium-ion battery before a rolling step.

FIG. 1B is a schematic cross-sectional view of an electrode plate material of a general lithium-ion battery after the rolling step.

FIG. 2A is a schematic cross-sectional view of an electrode plate material of a lithium-ion battery according to an embodiment of the present disclosure before a rolling step.

FIG. 2B is a schematic cross-sectional view of an electrode plate material of a lithium-ion battery according to an embodiment of the present disclosure after a rolling step.

FIG. 3A is a schematic micrograph of Embodiment 1.

FIG. 3B is a schematic micrograph of Comparative Example 1.

FIG. 4A is a schematic micrograph of Example 2.

FIG. 4B is a schematic micrograph of Comparative Example 2.

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, and etc., are only directions by referring to the accompanying drawings, and thus the used directional terms are used to describe and understand the present disclosure, but the present disclosure is not limited thereto.

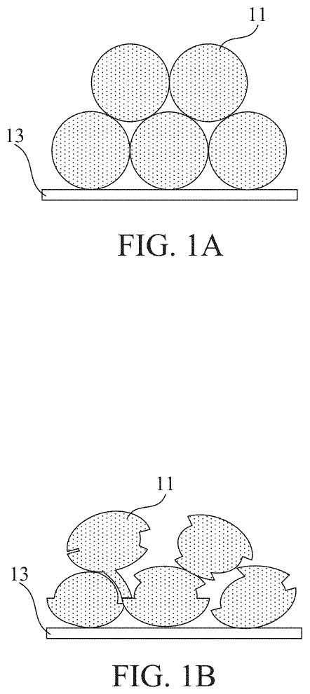

Please refer to FIG. 1A and FIG. 1B. It is noted that, when an electrode plate (a negative electrode material) is made, an electrode plate material of a lithium-ion battery on a substrate 13 usually undergoes a rolling step so that the electrode plate has a predetermined compaction density (for example, 1.0 to 2.0 g/cm³). However, for general single-component active materials 11, for example, silicon-based materials (such as Si, SiOₓ (x greater than 0 and less than or equal to 2)), tin-based materials (such as Sn, SnOₓ (x greater than 0 and less than or equal to 2)), lithium titanate (LTO), or harder carbon-based materials (such as soft carbon or hard carbon), etc., the general active material itself will be damaged or cracked after a rolling step. Therefore, when such damaged or cracked active materials are applied to the electrode plate of the lithium-ion battery, a cycle life of the battery will be reduced.

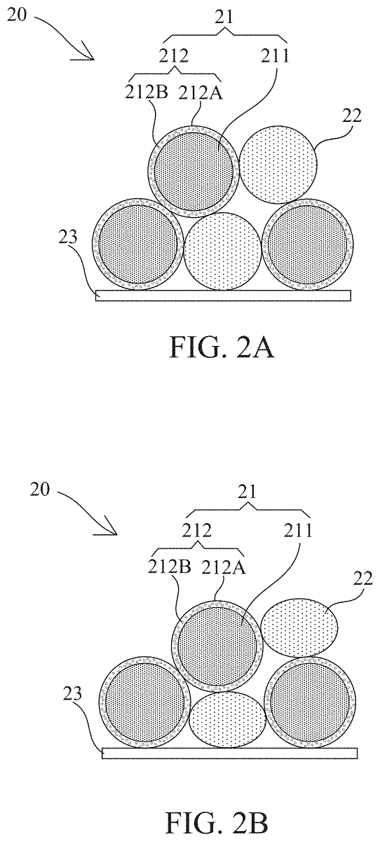

Accordingly, the present disclosure provides a new type of electrode plate material 20 for lithium-ion batteries. Please refer to FIGS. 2A and 2B. The electrode plate material 20 of the lithium-ion battery of an embodiment of the present disclosure includes: 5 to 70 parts by weight of an unbuffered active material 21, wherein the unbuffered active material 21 includes: a core 211; and a shell 212 covering the core 211; and 30 to 95 parts by weight of the buffered active material 22. In an embodiment, the unbuffered active material 21 is, for example, 6, 7, 8, 9, 10, 15, 20, 25, 30, 35, 40, 45, 50, 55, 60, 65, 66, 67, 68, or 69 parts by weight. In another embodiment, the buffered active material 22 is, for example, 31, 32, 33, 35, 40, 45, 50, 55, 60, 65, 70, 75, 80, 85, 90, 91, 92, 93, 94, or 95 parts by weight.

It is noted that the unbuffered active material described herein refers to an active material but is not used for buffering. In addition, the buffered active material described herein refers to an active material but it is mainly used for buffering.

According to the above, the present disclosure adds the buffered active material 22 as a buffered material to avoid or reduce the damage or rupture of the shell or the unbuffered active material 21 itself after the rolling step. In an aspect, the buffered active material 22 is softer than the unbuffered active material 21, so that it will preferentially bear stress during the rolling step, thereby protecting the unbuffered active material 21. On another aspect, since the material of the buffered active material 22 itself has the characteristics of storing lithium ions, it also contributes to electrical power characteristics of the lithium battery made using the electrode plate material 20 of the present disclosure.

It is mentioned that if the material of the core 211 is softer than the material of the shell 212, the shell 212 will be stressed from the outside to the inside when it is rolled, and the core 211 cannot support the shell due to the soft material, which will cause the shell 212 to crack. However, in the embodiment of the present disclosure, the presence of the buffered material can disperse the stress that the shell bears, thereby achieving the effect of protecting the shell material.

On the other hand, if the material of the core 211 is not softer than the material of the shell 212, the shell will be stressed from the outside to the inside when it is rolled. Since the material of the core 211 is not softer than the material of the shell 212, the material of the shell 212 is also subject to the reaction force from the inside to the outside of the core 211. At the same time, the material of the core 211 is also subjected to the stress from the outside to the inside of the shell 212, which will cause the shell 212 to crack and even the core 211 when subjected to the stress. However, in the embodiment of the present disclosure, in the presence of the buffered material, the stress that the dispersible material bears can be dispersed, thereby achieving the effect of protecting the material of the shell 212 and the core 211.

In an embodiment, the embodiment of the present disclosure basically does not limit the soft-hard relationship between the core 211 and the shell 212. In one example, the material of the core 211 is softer than the material of the shell 212. For example, the material of the core 211 includes graphite, and the material of the shell 212 includes a silicon-carbon composite material. In another example, the material of the core 211 is not softer than the material of the shell 212.

In addition, the present disclosure uses the unbuffered active material 21 with a specific structure and simultaneously uses it with the buffered active material 22, such that the electrode plate material 20 of the lithium-ion battery not only has higher initial capacity, first-time efficiency, but also has a high capacity retention rate (for example, the capacity retention rate of the 70th cycle).

In addition, it should be mentioned that the present disclosure can also use a softer unbuffered active material 21 (as opposed to the harder unbuffered active material 21 described above). As long as the buffered active material 22 is softer than the unbuffered active material, the unbuffered active material 21 can be protected by the buffered active material 22.

In one embodiment, the buffered active material 22 includes at least one of natural graphite, artificial graphite, or artificial conductive graphite. In general, natural graphite is softer than artificial graphite and artificial conductive graphite. In addition, it is generally recognized that artificial graphite has a better effect on the power characteristics of lithium batteries (for example, it can have a higher capacity retention rate). However, according to the following experimental results, it can be seen that the combination of natural graphite and artificial conductive graphite has a higher capacity retention rate. This is mainly because natural graphite is softer than artificial graphite. In addition, since artificial conductive graphite is added in a small amount in the following examples, it does not substantially affect the capacitance retention rate too much. It can be seen from the above that the softness of natural graphite (compared to artificial graphite) does contribute more to the effect on the capacity retention rate.

It is worth mentioning that the term “capacity” referred to in this article refers to “de-lithiation capacity”. The aforementioned de-lithiation capacity refers to the discharge capacity in electrochemistry, that is, the capacity measured when lithium ions are separated from the negative electrode back to the positive electrode, which is the capacity measured during a half-reaction process in the battery.

In an embodiment, the electrode plate material 20 of the lithium-ion battery of an embodiment of the present disclosure may further include additives, such as: a thickener greater than 0 and less than or equal to 5 parts by weight (for example, at least one of carboxymethyl cellulose (CMC), sodium polyacrylate, other silicon acrylate polymers, or fatty acid esters); an adhesive greater than 0 and less than or equal to 5 parts by weight (e.g. at least one of polyvinylidene fluoride (PVDF), styrene butadiene rubber (SBR), polyethylene, polypropylene, ethylene propylene polymer, butadiene rubber, butyl rubber, polyethylene oxide, polyepichlorohydrin, polyphosphazene, polyacrylonitrile, or polyimide); and/or a conductive additive greater than 0 and less than or equal to 5 parts by weight. In one embodiment, the type of the conductive additive is not particularly limited, as long as it is an electronic conductive material that does not decompose or change in the constituted battery. For example, metal powders or metal fibers such as Al, Ti, Fe, Ni, Cu, Zn, Ag, Sn, and/or Si can be used, or conductive carbon substrates can be used, such as natural graphite, artificial graphite, various coke powders, acetylene black, carbon black, vapor-grown carbon fiber, pitch-based carbon fiber, polyacrylonitrile-based carbon fiber, or various resin calcined bodies. The above-mentioned additives can be added according to the use range of the electrode plate material. For example, carboxymethyl cellulose, styrene butadiene rubber and conductive carbon black can be added to the water-based electrode plate material; or polyvinylidene fluoride can be added to the oily electrode plate material.

In one embodiment, an average particle size of the core 211 is between 16 and 20 microns (for example, about 18 microns), and a thickness of the shell 212 is between 2 to 3 microns (for example, about 2.5 microns). The shell 212 includes an amorphous carbon shell 212A and nano-silicon 212B (for example, between about 30 to 150 nanometers, such as about 100 nanometers, dispersed in the amorphous carbon shell 212A). The nano-silicon 212B is dispersed in and/or on the surface of the amorphous carbon shell). Each unbuffered active material 21 has close or similar electrical properties.

In the present disclosure, by adding a specific proportion of buffered active material (such as graphite particles) to avoid or reduce the damage or breakage of the shell 212 of the unbuffered active material 21, the cycle life of the battery can be improved (as shown in FIGS. 2A and 2B).

In an embodiment, the electrode plate material 20 of the lithium-ion battery of the present disclosure can be coated on a substrate 23, and produced through a general process (such as a rolling step) of the electrode plate of a lithium-ion battery, so as to form the electrode plate of the lithium-ion battery. Therefore, it is not repeated here again.

In another aspect, an embodiment of the present disclosure mainly uses a combination of specific substances in a specific ratio as the electrode plate material of the lithium-ion battery (i.e., 5 to 70 parts by weight of the unbuffered active material 21, wherein the unbuffered active material 21 includes: a core and a shell covering the core; and 30 to 95 parts by weight of the buffered active material 22), thereby avoiding the unbuffered active material itself (or the shell of the unbuffered active material) from being damaged or cracked during the rolling process. Therefore, the cycle life of the battery can be improved.

Several embodiments and comparative examples are listed below to illustrate that an electrode plate material of a lithium-ion battery of an embodiment of the present disclosure can indeed achieve the above-mentioned effects.

### Embodiment 1

Following are provided and mixed: 70 parts by weight of unbuffered active material (for example, including: a core of graphite material; and a shell covering the core, wherein the material of the shell includes, for example, a silicon-carbon composite material), 26 parts by weight of natural graphite, 4 parts by weight of artificial conductive graphite, 1.5 parts by weight of carboxymethyl cellulose, 3 parts by weight of styrene butadiene rubber, and 3.5 parts by weight of conductive carbon black (Super P). Then, the water is added to the above and are mixed to form a slurry. Then, the slurry is coated on a substrate (for example, copper foil) to make a pole piece. A coating weight of the substance on the pole piece is about 6 mg/cm². After drying the aforementioned substrate in a vacuum oven at about 85° C., a rolling step is performed to obtain a pole piece with a compaction density of 1.4 g/cm³.

### Embodiments 2-5 and Comparative Examples 1 and 2

Manufacturing methods of Embodiments 2-5 and Comparative Examples 1 and 2 are similar to those of Example 1, except that a ratio of unbuffered active material to graphite used and a compaction density are slightly different. Please refer to the table 1 below.

TABLE 1

| | | buffered active material | | | | | | |
|---|---|---|---|---|---|---|---|---|
| | | | | artificial | | | | |
| | unbuffered | natural | artificial | conductive | | | | 70th cycle |
| | active | graphite | graphite | graphite | compaction | initial | First-time | capacitance |
| | material (parts | (parts by | (parts by | (parts by | density | capacity | efficiency | maintenance |
| | by weight) | weight) | weight) | weight) | (g/cm3) | (mAh/g) | (%) | rate (%) |
| Embodiment | 70 | 26 | 0 | 4 | 1.4 | 459.7 | 87.5 | 95.8 |
| 1 | | | | | | | | |
| Embodiment | 70 | 26 | 0 | 4 | 1.6 | 460.8 | 87.1 | 94.7 |
| 2 | | | | | | | | |
| Embodiment | 70 | 0 | 30 | 0 | 1.4 | 460.4 | 88.3 | 95 |
| 3 | | | | | | | | |
| Embodiment | 70 | 0 | 30 | 0 | 1.6 | 458.9 | 87.5 | 92.1 |
| 4 | | | | | | | | |
| Embodiment | 5 | 0 | 95 | 0 | 1.6 | 378.6 | 90.0 | 99.9 |
| 5 | | | | | | | | |
| Comparative | 96 | 0 | 0 | 4 | 1.4 | 452.4 | 86.5 | 94.4 |
| example 1 | | | | | | | | |
| Comparative | 96 | 0 | 0 | 4 | 1.6 | 453.7 | 85.7 | 89.6 |
| example 2 | | | | | | | | |

Embodiments 1 to 5 and Comparative examples 1 and 2 are analyzed. For the capacity test, the charge and discharge rate of the first to fourth cycles are all set to 0.1 C-rate, and from the 5th cycle, the charging and discharging rate is set to 0.5 C-rate. The charge and discharge potential range is between 1 mV and 1.5 V. In the test of charge and discharge performance, the charge and discharge performance of a lithium battery is determined by a coulombic efficiency and capacity retention rate of the battery, where the coulombic efficiency is a ratio of the capacity of lithium deintercalation per cycle to the capacity of lithium intercalation. The capacity retention rate is a ratio of the lithium insertion capacity of each cycle to the lithium insertion capacity of the first cycle. Therefore, the capacity retention rate of the 70th cycle is a ratio of the capacity of lithium deintercalation of the 70th cycle to the capacity of lithium deintercalation of the first cycle. The 1 C charge capacity is a capacity obtained during the constant current charging stage at the 1 C-rate charging rate divided by the total capacity (constant current capacity+constant voltage capacity). The 5 C discharge capacity is the capacitance obtained by constant current discharge at a discharge rate of 5 C-rate divided by the capacitance obtained by constant current discharge at a discharge rate of 0.2 C.

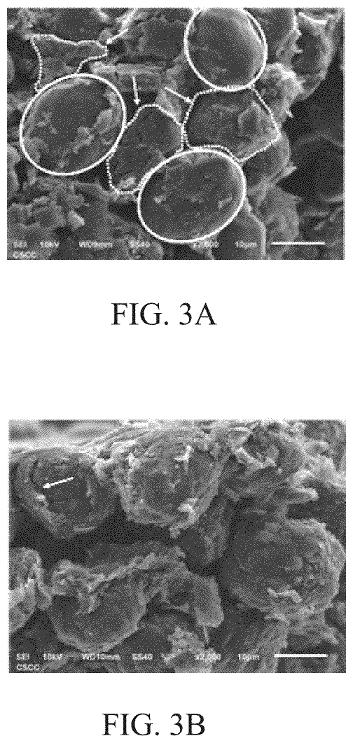

Compared with Embodiment 1 and Comparative Example 1, under the same compaction density, the capacity retention rates of Embodiment 1 and Comparative Example 1 after the 70th cycle are 95.8% and 94.4%, respectively. This indicates that the cycle life of Embodiment 1 is better than that of Comparative Example 1. This is because the surface of the unbuffered active material shell (such as silicon-carbon composite material) of Embodiment 1 can maintain the original appearance without being damaged after the electrode plate density is rolled to 1.4 g/cm³ (as shown in the arrow in FIG. 3A, Shown by dashed and solid lines). In Comparative Example 1, after the electrode plate density is rolled to 1.4 g/cm³, some particles can be found to be broken (as shown by the arrow in FIG. 3B), which affects the stability of the unbuffered active material during the subsequent cycle test.

In another aspect, the factors that cause the different degree of rupture of the unbuffered active materials after rolling are: there is not enough natural/artificial graphite as the buffered material between the unbuffered active materials. Therefore, after rolling, the unbuffered active materials squeeze each other to cause surface cracks to be more serious, which in turn causes a rapid decline in cycle life. Conversely, when there are enough natural graphite/artificial graphite/artificial conductive materials between the unbuffered active materials as the buffered material, the unbuffered active material still maintains a relatively complete particle shape.

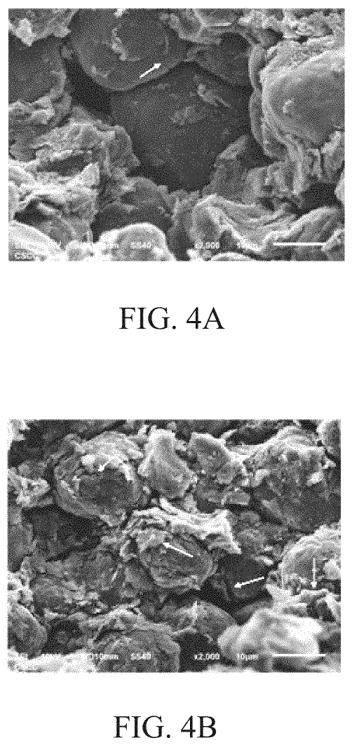

With respect to Comparative Example 2 and Embodiment 2, it can be more clearly found that the high rolling density has a significant impact on the cycle life. When rolled to 1.6 g/cm³, the unbuffered active material of Embodiment 2 only showed partial cracks (as shown by an arrow in FIG. 4A). In Comparative Example 2, a large number of cracks and ruptures (as indicated by the arrows in FIG. 4B) occurred. Therefore, the cycle life of Embodiment 2 is much better than that of Comparative Example 2. Similarly, the cycle life of Embodiments 3 and 4 is also better than that of Comparative Examples 1 and 2, respectively.

It can also be observed from Embodiment 5 that even if the electrode plate density is rolled to 1.6 g/cm³, since the buffered material of Embodiment 5 is as high as 95%, it has an excellent buffering effect. The unbuffered active material hardly breaks during rolling, such that the capacity retention rate after the 70th cycle is still as high as 99.9%.

Regarding Embodiments 1 and 3, it can be seen that the combination of natural graphite and artificial conductive graphite has a higher capacity retention rate. This is mainly because natural graphite is softer than artificial graphite. In addition, since the amount of artificial conductive graphite added is small, it does not substantially affect the capacity retention rate. It can be seen from the above that the softness of natural graphite does contribute more (compared to artificial graphite) to the capacity retention rate. More specifically, in terms of the cycle performance of pure graphite as the active material of lithium-ion batteries, the cycle life of artificial graphite is generally better than that of natural graphite. However, if a certain proportion of silicon-containing active materials is added, the negative impact of silicon on the cycle life will be far greater than the impact of graphite on the cycle life. Combining the above two points, together with the results of the Embodiments and Comparative Examples of this case, it can be confirmed that softer buffered active materials such as natural graphite help maintain the cycle life of silicon-containing active materials. Although the buffering effect of artificial graphite used in this case is not as good as natural graphite, artificial graphite still has a buffering effect compared to unbuffered active materials, which can protect unbuffered active materials, so the addition of artificial graphite will still improve the cycle life.

Regarding Comparative Example 1 and Comparative Example 2, there is also insufficient natural/artificial graphite as a buffered material between the unbuffered active materials of the two. However, the cycle life of Comparative Example 2 is more significantly degraded than that of Comparative Example 1. It can be seen from FIG. 3B and FIG. 4B that the unbuffered active materials of Comparative Example 2 extrude each other to cause more serious surface cracks, which in turn causes a faster decline in cycle life.

TABLE 2

| | un- | buffered active material | | | | |
|---|---|---|---|---|---|---|
| | buffered | | | artificial | | |
| | active | natural | artificial | conductive | 1 C | 5 C |
| | material | graphite | graphite | graphite | charge | charge |
| | (parts by | (parts by | (parts by | (parts by | capacity | capacity |
| | weight) | weight) | weight) | weight) | (%) | (%) |
| Embodiment | 70 | 26 | 0 | 4 | 58.0 | 88.8 |
| 2 | | | | | | |
| Embodiment | 5 | 0 | 95 | 0 | 40.8 | 61.3 |
| 5 | | | | | | |
| Comparative | 96 | 0 | 0 | 4 | 55.3 | 83.9 |
| example 2 | | | | | | |

Compared with the charge and discharge capacities of Embodiment 2, Embodiment 5 and Comparative Example 2. Embodiment 5 performs the worst, which accounts for the highest proportion of buffered active materials (95%). Embodiment 2 performs best, which accounts for the second largest proportion (30%), performs best. The charge and discharge capacity of Comparative Example 2 with the lowest proportion (4%) is between the two. The charge and discharge capacity of Embodiment 5 is slightly worse than that of Comparative Example 2. However, Embodiment 5 has an excellent buffering effect, and it still has its application scenarios (for example, under applications that require high compaction density and long cycle life but only ordinary charge/discharge capacity).

In summary, through the analysis of Embodiments 1 to 5 and Comparative Examples 1 and 2, it can be seen that in the embodiments of the present disclosure, buffered active materials are added to avoid the unbuffered active material with a specific structure itself (and/or shell) breaking or cracking. In addition, it should be mentioned that the comparative examples 1 and 2 here are only used as a control group, not a conventional technology. More specifically, the present disclosure uses a combination of an unbuffered active material with a specific structure and a buffered material, which can avoid or reduce the damage or rupture of the unbuffered active material and at the same time have the effect of improving the cycle life. The above-mentioned features have not been disclosed or suggested by any prior art.

The present disclosure has been described with a preferred embodiment thereof and it is understood that many changes and modifications to the described embodiment can be carried out without departing from the scope and the spirit of the disclosure that is intended to be limited only by the appended claims.

1. An electrode plate material of lithium-ion battery, comprising:
5 to 70 parts by weight of unbuffered active material, comprising:
a core; and
a shell covering the core; and
30 to 95 parts by weight of buffered active material.

2. The electrode plate material of lithium-ion battery according to claim 1, wherein the buffered active material comprises at least one of natural graphite, artificial graphite, or artificial conductive graphite.

3. The electrode plate material of lithium-ion battery according to claim 1, further comprising a thickener greater than 0 and less than or equal to 5 parts by weight.

4. The electrode plate material of lithium-ion battery according to claim 3, wherein the thickener comprises at least one of carboxymethyl cellulose, sodium polyacrylate, other silicon acrylate polymers, or fatty acid esters.

5. The electrode plate material of lithium-ion battery according to claim 1, further comprising an adhesive greater than 0 and less than or equal to 5 parts by weight.

6. The electrode plate material of lithium-ion battery according to claim 5, wherein the adhesive comprises at least one of polyvinylidene fluoride, styrene butadiene rubber, polyethylene, polypropylene, ethylene propylene polymer, butadiene rubber, butyl rubber, polyethylene oxide, polyepichlorohydrin, polyphosphazene, polyacrylonitrile, or polyimide.

7. The electrode plate material of lithium-ion battery according to claim 1, further comprising a conductive additive greater than 0 and less than or equal to 5 parts by weight.

8. The electrode plate material of lithium-ion battery according to claim 7, wherein the conductive additive comprises at least one of metal powder, metal fiber, or conductive carbon substrate.

9. The electrode plate material of lithium-ion battery according to claim 1, wherein an average particle size of the core is between 16 and 20 microns, and a thickness of the shell is between 2 and 3 microns, wherein the shell comprises an amorphous carbon shell and nano-silicon dispersed on the amorphous carbon shell.

10. The electrode plate material of lithium-ion battery according to claim 1, wherein the buffered active material is softer than the unbuffered active material.
